(19) United States
(12) Patent Application Publication
(10) Pub. No.: US 2022/0188840 A1
(43) Pub. Date: Jun. 16, 2022

(54) TARGET ACCOUNT DETECTION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Maoli LAI, Shenzhen (CN); Hanchang Wu, Shenzhen (CN); Chong Ding, Shenzhen (CN); Long Chen, Shenzhen (CN)

(73) Assignee: TENCENT TECHNOLOGY (SHENZHEN) COMPANY LIMITED, Shenzhen (CN)

(21) Appl. No.: 17/687,049

(22) Filed: Mar. 4, 2022

Related U.S. Application Data
(63) Continuation of application No. PCT/CN2020/126090, filed on Nov. 3, 2020.

(30) Foreign Application Priority Data
Feb. 7, 2020 (CN) 202010082544.2

(51) Int. Cl. G06Q 30/00; A63F 13/75; G06N 5/02

(52) U.S. Cl. CPC G06Q 30/0185; A63F 2300/5586; G06N 5/022; A63F 13/75

(57) ABSTRACT

A target account detection method and apparatus, an electronic device, and a storage medium. The method includes: determining an active behavior timing feature of a target account to be detected according to active behavior data of the target account; determining an account feature of the target account according to account data of the target account; predicting a first probability that the target account is of a target type; and determining, in response to the first probability being greater than a target probability threshold, that the target account is of the target type. Detection is performed in the dimension of timing, so that the impact of an account of a target type pretending to be a normal account on detection can be reduced, and more accounts of the target type can be detected, thereby enlarging the identification coverage.

### CROSS-REFERENCE TO RELATED APPLICATION(S)

This application is a continuation application of International Application No. PCT/CN2020/126090, filed on Nov. 3, 2020 which claims priority to Chinese Patent Application No. 202010082544.2, filed with the China National Intellectual Property Administration on Feb. 7, 2020, the disclosures of which are incorporated by reference in their entireties.

### FIELD

The disclosure relates to the field of artificial intelligence (AI) technologies, and in particular, to a target account detection method and apparatus, an electronic device, and a storage medium.

### BACKGROUND

With the development of Internet technologies, various Internet services, such as shopping services, meal ordering services, video-on-demand services, and gaming services, continuously emerge. Using gaming services as an example, users may experience content of the gaming services by logging in to game accounts, may buy virtual items for virtual characters corresponding to the game accounts, or may participate in various events held by a game operator, to obtain rewards. However, there are also a large quantity of abnormal game accounts in the games, the abnormal game accounts obtain rewards provided in the game events through cheating or other means, which affects normal game accounts from obtaining rewards and interferes with normal operation of the games.

Currently, to identify abnormal game accounts, data information corresponding to game accounts is generally collected as a data source, and weights are assigned to different features included in the data information, to obtain weight information of the features. Based on the weight information, the game accounts are classified, to identify abnormal game accounts and process the abnormal game accounts.

### SUMMARY

Embodiments of the disclosure may provide a target account detection method and apparatus, an electronic device, and a storage medium, to identify more accounts of a target type by introducing an active behavior timing feature of a target account to be detected and further referring to an account feature, thereby improving the identification coverage. The technical solutions are as follows:

According to an aspect, a target account detection method is provided, performed by an electronic device, the method including:

determining an active behavior timing feature of a target account to be detected according to active behavior data of the target account, the active behavior data being used for representing whether the target account is active in a target duration;

determining an account feature of the target account to be detected according to account data of the target account;

predicting, based on the account feature and the active behavior timing feature, a first probability that the target account is of a target type; and

determining, in response to the first probability being greater than a target probability threshold, that the target account is of the target type.

According to an aspect, a target account detection apparatus is provided, the apparatus including:

a determining module, configured to determine an active behavior timing feature of a target account to be detected according to active behavior data of the target account, the active behavior data being used for representing whether the target account is active in a target duration,

the determining module being further configured to determine an account feature of the target account according to account data of the target account; and

a prediction module, configured to predict, based on the account feature and the active behavior timing feature, a first probability that the target account is of a target type,

the determining module being further configured to determine, in response to the first probability being greater than a target probability threshold, that the target account is of the target type.

According to an aspect, an electronic device is provided, including a processor and a memory, the memory being configured to store at least one computer program instruction, the at least one computer program instruction being loaded and executed by the processor to implement the operations performed in the target account detection method in the embodiments of the disclosure.

According to another aspect, a storage medium is provided, the storage medium being configured to store at least one computer program instruction, the at least one computer program instruction being used for performing the target account detection method in the embodiments of the disclosure.

According to another aspect, a computer program product or a computer program is provided, including computer program instructions, the computer program instructions being stored in a computer-readable storage medium. A processor of an electronic device reads the computer program instructions from the computer-readable storage medium, and executes the computer program instructions, so that the electronic device performs the target account detection method provided in the foregoing aspects or the various optional implementations of the aspects.

The technical solutions provided in the embodiments of the disclosure have the following beneficial effects:

In the example embodiments of the disclosure, detection can be performed in the dimension of timing by introducing an active behavior timing feature of a target account and determining, according to the active behavior timing feature and an account feature of the target account, a first probability that the target account is of a target type, so that the impact of an account of a target type pretending to be a normal account on detection can be reduced, and more accounts of the target type can be detected, thereby enlarging the identification coverage.

### BRIEF DESCRIPTION OF THE DRAWINGS

To describe the technical solutions of the example embodiments of this disclosure more clearly, the following briefly introduces the accompanying drawings required for describing the embodiments. The accompanying drawings herein are incorporated into the specification and constitute a part of this specification, show embodiments that conform to the disclosure, and are used for describing a principle of the disclosure together with this specification. The accompanying drawings in the following description show only some embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a structural block diagram of an account detection system according to an embodiment of the disclosure.

FIG. 2 is a flowchart of a target account detection method according to an embodiment of the disclosure.

FIG. 3 is a schematic diagram of numeric transformation according to an embodiment of the disclosure.

FIG. 4 is a schematic diagram of a first feature matrix according to an embodiment of the disclosure.

FIG. 5 is a schematic diagram of an objective function of a clustering algorithm according to an embodiment of the disclosure.

FIG. 6 is a schematic diagram of cluster center correction according to an embodiment of the disclosure.

FIG. 7 is a schematic diagram of active behavior vector compression according to an embodiment of the disclosure.

FIG. 8 is a schematic diagram of determining an active behavior timing feature according to an embodiment of the disclosure.

FIG. 9 is a schematic diagram of an operation mode of a workshop according to an embodiment of the disclosure.

FIG. 10 is a flowchart of another target account detection method according to an embodiment of the disclosure.

FIG. 11 is a schematic diagram of a supervised learning model framework according to an embodiment of the disclosure.

FIG. 12 is a schematic diagram of a learning framework according to an embodiment of the disclosure.

FIG. 13 is a flowchart of a calculation according to an embodiment of the disclosure.

FIG. 14 is an architectural diagram of a value model according to an embodiment of the disclosure.

FIG. 15 is a schematic diagram of probability logic according to an embodiment of the disclosure.

FIG. 16 is a flowchart of another target account detection method according to an embodiment of the disclosure.

FIG. 17 is a block diagram of a target account detection apparatus according to an embodiment of the disclosure.

FIG. 18 is a schematic structural diagram of a terminal according to an embodiment of the disclosure.

FIG. 19 is a schematic structural diagram of a computer device according to an embodiment of the disclosure.

### DESCRIPTION OF EMBODIMENTS

To make the objectives, technical solutions, and advantages of the disclosure clearer, the following further describes implementations of the disclosure in detail with reference to the accompanying drawings.

In the related art, because a relatively small quantity of features are selected during classification of game accounts, and abnormal game accounts usually pretend to be normal game accounts, abnormal game accounts cannot be identified effectively, resulting in low identification coverage.

Example embodiments are described in detail herein, and examples of the example embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with the disclosure. On the contrary, the implementations are merely examples of apparatuses and methods that are described in detail in the appended claims and that are consistent with some aspects of the disclosure.

Technologies that may be used in the example embodiments of the disclosure are briefly described below:

Artificial intelligence (AI) is a theory, method, technology, and application system in which a digital computer or a machine controlled by a digital computer is used to simulate, extend, and expand human intelligence, sense an environment, acquire knowledge, and use the knowledge to obtain an optimal result. In other words, Al is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated Al chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning (ML)/deep learning (DL).

Nature Language Processing (NLP) is an important direction in the fields of computer science and AI. NLP studies various theories and methods for implementing effective communication between human and computers through natural languages. NLP is a science that integrates linguistics, computer science and mathematics. Therefore, studies in this field relate to natural languages, that is, languages used by people in daily life, and NLP is closely related to linguistic studies. NLP technologies usually include text processing, semantic understanding, machine translation, robot question answering, knowledge graphs and other technologies.

ML is a multi-field interdiscipline, and relates to a plurality of disciplines such as the probability theory, statistics, the approximation theory, convex analysis, and the algorithm complexity theory. The ML specializes in studying how a computer simulates or implements a human learning behavior to obtain new knowledge or skills, and reorganize an existing knowledge structure, so as to keep improving its performance. The ML is the core of AI, is a basic way to make the computer intelligent, and is applied to various fields of AI. The ML and deep learning generally include technologies such as an artificial neural network, a belief network, reinforcement learning, transfer learning, inductive learning, and learning from demonstrations.

The target account detection method provided in the example embodiments of the disclosure can be used in a scenario of detecting accounts of a target type. For example, in shopping-related scenarios, scalper accounts, scalping accounts, and the like are detected; in social-related scenarios, accounts suspected of fraud and the like are detected; and in gaming scenarios, accounts that affect operation of games through cheating, for example, workshop accounts, are detected. Using detecting workshop accounts as an example, gaming workshops usually register a large quantity of game accounts, that is, workshop accounts, and accumulate game tokens, obtain event rewards, and so on by using automatic hang-up scripts and participating in a large quantity of events held during operation of games, so as to accumulate a large quantity of virtual assets, and then the gaming workshops make a profit based on the virtual assets through means such as batch transfer and abnormal transactions. Such a method affects normal incomings of game operators. In addition, in the initial stage of the launch of a new game, the game is still in the testing stage, and the game operator needs to determine the performance of the game from the participation of users. Active behaviors of a large quantity of workshop accounts may mislead the overall performance of the game, and cause the game operator to waste a lot of operating resources. In view of the above, detecting and processing workshop accounts or other abnormal game accounts is a very important part in a game operation process.

Main operations of the target account detection method provided in the embodiments of the disclosure are briefly described below. Currently, in the related art, after features are obtained through feature engineering, data cleaning is performed based on weights assigned to the features, then, a plurality of features are combined, and a detection model is constructed based on the combined features using an ML method, to detect target accounts. Feature dimensions selected through this method are relatively limited, and can be fooled by disguised accounts, resulting in low detection coverage, that is, accounts of many target types cannot be detected. Moreover, this method is less robust. After the game is run for a period of time, the detection model needs to be updated and upgraded with the development of the game operation, and even after a major version update of the game, the detection model needs to be overturned and re-built. However, the embodiments of the disclosure provide a target account detection method. First, an active behavior timing feature of a target account to be detected is determined according to active behavior data of the target account. All time variation-related features are transformed into expressions similar to a time sequence, to form an active behavior timing feature. Then, an account feature of the target account, that is, a feature other than the active behavior timing feature, is detected according to account data of the target account. Subsequently, a first probability that the target account is of a target type is predicted based on the account feature and the active behavior timing feature. Finally, in response to the first probability being greater than a target probability threshold, it is determined that the target account is of the target type. Therefore, the target account is detected.

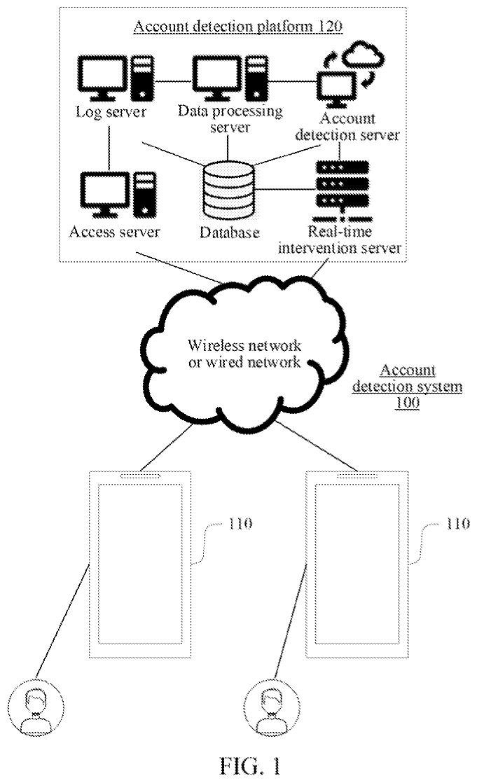

FIG. 1 is a structural block diagram of an account detection system 100 according to an embodiment of the disclosure. The account detection system 100 includes a terminal 110 and an account detection platform 120.

The terminal 110 is connected to the account detection platform 120 by using a wireless network or a wired network. In some embodiments, the terminal 110 is at least one of a smartphone, a game console, a desktop computer, a tablet computer, an e-book reader, a moving picture experts group layer-3 (MP3) player, a moving picture experts group layer-4 (MP4) player, or a laptop portable computer. An application program supporting account detection is installed and run on the terminal 110. For example, this application program is a game application program, a social application program, a shopping application program, or the like. For example, the terminal 110 is a terminal used by a user, and the application program running on the terminal 110 logs in to a user account.

The account detection platform 120 includes at least one of a server, a plurality of servers, a cloud computing platform, or a virtualization center. The account detection platform 120 is configured to provide a background service for the application program that supports account detection. In some embodiments, the account detection platform 120 undertakes primary detection work, and the terminal 110 undertakes secondary detection work. Alternatively, the account detection platform 120 undertakes secondary detection work, and the terminal 110 undertakes primary detection work. Alternatively, the account detection platform 120 or the terminal 110 may separately undertake detection work.

In some embodiments, the account detection platform 120 includes an access server, a log server, a data processing server, an account detection server, a real-time intervention server, and a database. The access server is configured to provide an access service for the terminal 110. The log server is configured to collect behavior logs of users. The data processing server is configured to perform intervention processing on the collected data. The account detection server is configured to detect the target account. The real-time intervention server is configured to perform intervention processing on the detected target account. In some embodiments, there is one or more account detection servers. When there are a plurality of account detection servers, at least two account detection servers are configured to provide different services, and/or at least two account detection servers are configured to provide the same service, for example, provide the same service in a load balancing manner, which is not limited in this embodiment of the disclosure. The behavior logs of the users collected by the log server are used for authorized information.

The terminal 110 generally refers to one of a plurality of terminals. In this embodiment, the terminal 110 is merely used as an example for description. In some embodiments, a person skilled in the art may understand that, there may be more or fewer terminals. For example, there may be only one terminal, or there may be dozens of or hundreds of or more terminals. In this case, the account detection system further includes another terminal. The quantity and the device types of the terminals are not limited in the embodiments of the disclosure.

The operations may be performed by a computer device. The computer device may be any electronic device with processing and storage capabilities, for example, an electronic device such as a mobile phone, a tablet computer, a game console, a multimedia playback device, an electronic photo frame, a wearable device, a personal computer (PC), or an in-vehicle computer, or may be a server or the like. For the ease of description, in the following method embodiments, the descriptions are provided merely based on that the operations are performed by a computer device.

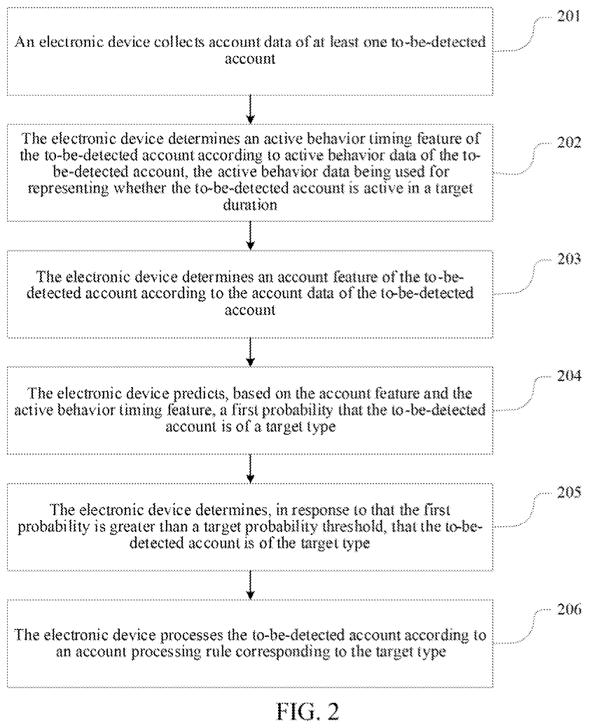

FIG. 2 is a flowchart of a target account detection method according to an embodiment of the disclosure. As shown in FIG. 2, descriptions are provided in this embodiment of the disclosure by using an example in which the method is applied to an electronic device. The target account detection method includes following operation:

201. The electronic device collects account data of at least one target account to be detected (or referred to as a to-be-detected account).

In this embodiment of the disclosure, the target account is a game account, a social account, a shopping account, or the like. Using an example in which the target account is a game account, detecting an account of a target type is equivalent to detecting a workshop account in a game. The electronic device can collect and sort account data, such as a behavior log, a user portrait, and event information, of at least one game account in a game during game operation. The behavior log is used for recording a frequency and degree at which the game account participates in the game, for example, game durations, login records, a login frequency, consumption records, and a consumption count. The user portrait mainly refers to the age, the gender, the province, device information, Internet Protocol (IP) information, and the like of the user of the game account. The event information includes account identifiers of game account participating in events and consumption information of the game accounts in the events.

In some embodiments, the electronic device first needs to perform outlier processing on the collected data. The outlier processing is mainly processing error values, missing values, redundant values, values that do not conform to the variation trend, and the like in the collected data. The error values can be directly corrected by the electronic device. For example, within one day, a behavior log that is greater than 24 hours is an obviously illogical error value, and the electronic device corrects the behavior log to 24 hours. For the missing values, the electronic device can complete the missing values according to the context or related data. For the redundant values, the electronic device deletes the redundant parts. For the values that do not conform to the variation trend, the electronic device processes, by using a quartile processing method, the data that does not conform to the variation trend. The quartiles, also referred to as quartile points, refer to values at positions of three dividing points when all values are arranged in ascending order and divided into four equal parts in statistics, and are mostly applied to box plot drawing in statistics. The quartiles are values at the 25% and 75% positions after a set of data is sorted. The quartiles divide all the data into 4 parts by 3 points, each part including 25% of the data. The quartile in the middle is a median. Therefore, the quartiles generally mean a value at the 25% position (referred to as a lower quartile) and a value at the 75% position (referred to as an upper quartile). Similar to the calculation method of the median, when the quartiles are calculated according to ungrouped data, the data is first sorted, and then, positions of the quartiles are determined. The values at the positions are the quartiles. Different from the median, there are several methods for determining the positions of the quartiles, and results obtained through the methods may be different, but are not greatly different. The electronic device can alternatively use another outlier processing method, which is not limited in the disclosure. By performing outlier processing on the collected data, abnormal data is eliminated to ensure the confidence of the data.

In some embodiments, the electronic device constructs feature information by performing numeric transformation on the collected data. First, the electronic device divides the account data into a plurality of types of data. Then, the electronic device performs normalization on the plurality of types of data. The normalization is used for changing a value range of the data into a target value range. In the plurality of types of data obtained through division, at least one type of data belongs to active behavior data. The active behavior data is used for representing whether the target account is active during a target duration.

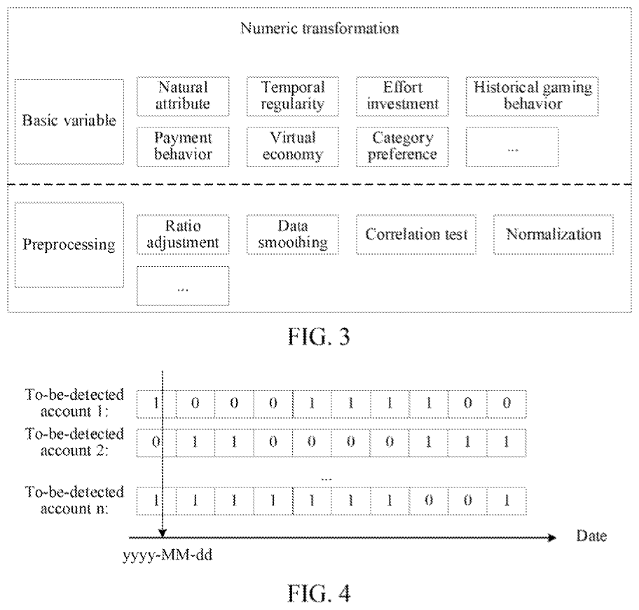

For example, FIG. 3 is a schematic diagram of numeric transformation according to an embodiment of the disclosure. In FIG. 3, the electronic device processes the collected data into various thematic data, for example, a plurality of types of data such as natural attributes (the age, gender, province, city, and occupation), and the temporal regularity (a login time, a login frequency, a logout time, and the like), effort investment (the shortest game duration, the longest game duration, the average game duration, and the like), historical gaming behaviors, payment behaviors, virtual economy (tokens, coupons, virtual props, and the like), and category preference. The types of data are referred to as basic variables. Then, the electronic device preprocesses the basic variables, for example, adjusts a scale value of scale data, stretches and forms values to make the data smooth, or conducts a correlation test on the data. In another example, normalization is performed on the data to change a value range of data into a target value range. For example, features of different dimensions are normalized to a range of 0 to 1 through minimum/maximum (Min/Max) standardization, which facilitates comparison and subsequent processing of data while accelerating subsequent convergence of the model.

202: The electronic device determines an active behavior timing feature of the target account according to active behavior data of the target account, the active behavior data being used for representing whether the target account is active in a target duration.

In this embodiment of the disclosure, after obtaining account data of at least one target account, the electronic device can extract active behavior data from the account data. Different the conventional feature project of directly processing data into a one-dimensional scalar. In this embodiment of the disclosure, the active behavior data are not directly quantized for statistics. Instead, dimension raising is first performed on the active behavior data, and then dimension reduction is performed on the active behavior data, to explore the active behavior timing feature. In this way, differences between features having information compressed in the low-dimension can be shown through dimension raising

For example, a user A spends 100 yuan on a specific day, and a user B spends 100 yuan on a specific day. The information has only one dimension, that is, an amount dimension, and is one-dimensional information. A conclusion is that the user A and the user B spend the same amount. However, the user B spends 100 yuan every day in a week, and the user A spends a total of 100 yuan in a week. Consumption information of a user in a week has two dimensions, namely, an amount dimension and a time dimension, and is two-dimensional information. The two-dimensional information can show a difference between the user A and the user B in terms of consumption.

In some embodiments, this operation is implemented through 2021 to 2023.

2021: The electronic device performs dimension raising on the active behavior data of the target account, to obtain a first feature matrix.

The electronic device can perform dimension raising on the active behavior data by using a binomial bitmap, and convert the active behavior data into a form of a binomial bitmap, to obtain the first feature matrix. The binomial bitmap indicates that elements in the bitmap is represented by 0 and 1. A quantity of rows of the first feature matrix is 1, and a quantity of columns is a target duration, for example, 10 hours, 24 hours, 10 days, 30 days, or the like. Through dimension raising, the time distribution of active behaviors of the target account can be retained, to facilitate subsequent processing of sliding window-style active behavior data. In addition, the construction of the binomial bitmap makes the active behavior data conform to the Bernoulli distribution, which can satisfy the data distribution condition required by a plurality of algorithms.

For example, FIG. 4 is a schematic diagram of a first feature matrix according to an embodiment of the disclosure. FIG. 4 shows a first feature matrix corresponding to n target accounts. Each first feature matrix includes 10 columns. Each column corresponds to 1 day. Whether the target account is active on a corresponding date is represented by 0/1, where 0 means inactive, and 1 means active. A sequence feature similar to the first feature matrix can also be constructed using other active behavior data. For example, a sequence feature (0.4, 0.2, 0.1, 0, 0.5, 0.7 . . . ) is constructed using event frequencies, which is not limited in this embodiment of the disclosure.

2022: The electronic device performs clustering based on the first feature matrix, to obtain at least one cluster.

In some embodiments, first, the electronic device combines the first feature matrix and a second feature matrix of at least one sample account into a third feature matrix, a type of the sample account being known. Then, the electronic device divides the third feature matrix into a plurality of feature groups according to a time dimension. Subsequent, based on the K-means (a clustering algorithm) algorithm, a K-means objective function is modified. Similarities between samples are quantized by using Euclidean distances of a rectangular coordinate system and are modified into similarities between samples dequantized according to cosine values of a polar coordinate system, so as to determine similarities between the plurality of feature groups. Finally, the electronic device divides the plurality of feature groups into at least one cluster according to the similarities between the plurality of feature groups. In some embodiments, the electronic device can further combine first feature matrices of two or more target accounts with a second feature matrix of at least one sample account, that is, perform clustering on two or more target accounts at a time, to determine active behavior timing features of a plurality of target accounts.

For example, FIG. 5 is a schematic diagram of an objective function of a clustering algorithm according to an embodiment of the disclosure. FIG. 5 shows an objective function Σ(1−dist(A,B)) of calculating a Euclidean distance using a rectangular coordinate system before modification, and an objective function Σ(1−cos(A,B)) using a cosine value of a polar coordinate system after the modification.

In some embodiments, because clustering is an unsupervised method, the initial random selection of a clustering center may affect the bias of the clustering. Moreover, in normal cases, behaviors of a user cannot be completely consistent, and therefore, active behavior data corresponding to a target account is not completely consistent. However, active behaviors of an account of a target type may tend to be consistent. For example, because an operation mode of a workshop is relatively fixed, active behaviors of a workshop account tend to be consistent. In some embodiments, when the account of the target type is detected, a semi-supervised method is used to draw the clustering center in each round of clustering, so as to find a final clustering center in a heuristic clustering manner. After dividing the plurality of features into at least one cluster, the electronic device determines, in response to any cluster including a largest quantity of sample accounts, a displacement coefficient of the cluster, the displacement coefficient being a ratio of a quantity of sample accounts not included in the cluster to a total quantity of sample accounts. The electronic device determines a target distance according to a distance between a first clustering center of the cluster and a preset second clustering center and the displacement coefficient, the second clustering center being a clustering center determined in a heuristic clustering manner. The electronic device moves the first clustering center by the target distance in a direction pointing to the second clustering center.

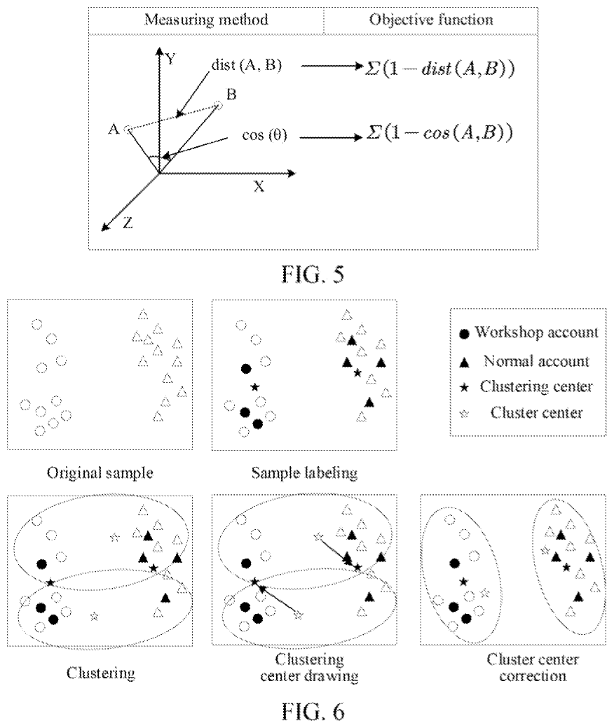

For example, FIG. 6 is a schematic diagram of cluster center correction according to an embodiment of the disclosure. In FIG. 6, original samples include a target account and sample accounts. The sample accounts are workshop account and normal accounts. The sample accounts are labeled. Two sample clustering centers of the labeled samples are obtained. One is a workshop account clustering center, and the other is a normal account clustering center. After clustering, two clusters are obtained, which are respectively a cluster that includes the most workshop accounts and the cluster that includes the most normal accounts. To facilitate distinction, clustering centers of the two obtained clusters are referred to as cluster centers, there are distance differences between the two cluster centers and the two sample clustering centers. Clustering center drawing is performed respectively on the cluster that includes the most workshop accounts and the cluster that includes the most normal accounts. Using the cluster that includes the most workshop accounts as an example, the electronic device determines, according to a ratio of a quantity of workshop accounts not in the cluster to a total quantity of the workshop accounts in the samples as a displacement coefficient, determine a distance between the cluster that includes the most includes workshop accounts and the workshop account clustering center, that is, a length of a vector formed by the cluster center of the cluster that includes the most workshop accounts and the workshop account clustering center, and uses a product of the displacement coefficient and the length of the vector as a target distance. The cluster center of the cluster that includes the most workshop accounts is moved in a direction pointing to the workshop account clustering center, that is, a vector direction, by the target distance. After the clustering center drawing is completed, the cluster center is corrected.

In some embodiments, in addition to distinguishing between the target account and the sample accounts using the clustering method, the electronic device can further distinguish between the target account and the sample accounts using another method such as a clustering algorithm, a classification method, and shortest distance calculation, which is not limited in this embodiment of the disclosure.

2023. The electronic device determines the active behavior timing feature of the target account according to the at least one cluster.

The electronic device obtains, in the at least one cluster, a third clustering center of a first cluster and a fourth clustering center of a second cluster, the first cluster being a cluster corresponding to accounts of the target type, and the second cluster being a cluster corresponding to accounts of non-target types. The electronic device processes the third clustering center, the fourth clustering center, and the first feature matrix respectively by using a Hamming weight and a Hamming distance, to obtain the active behavior timing feature of the to-be-detected account. The Hamming weight is used for quantizing an activity level similarity, and the Hamming distance is used for quantizing an activity regularity similarity.

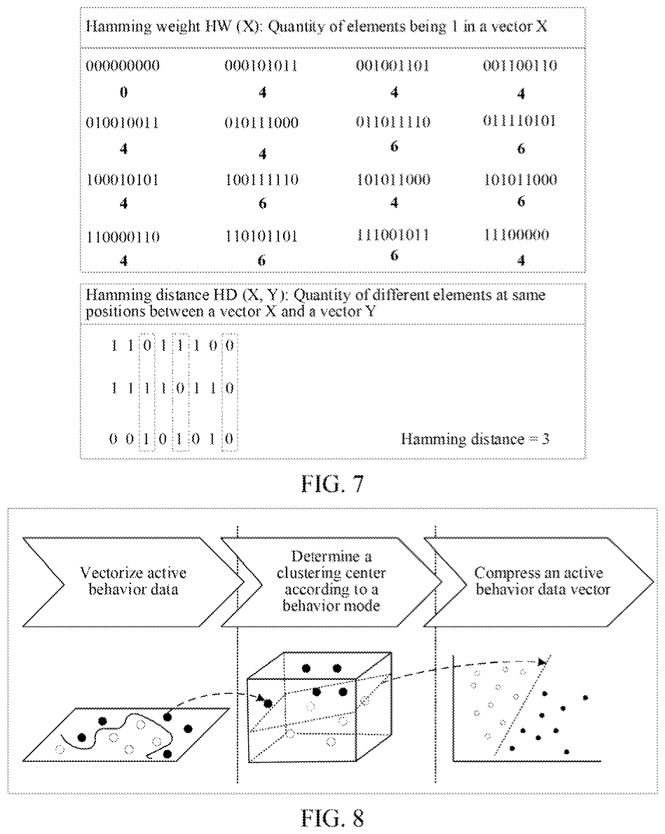

For example, FIG. 7 is a schematic diagram of active behavior vector compression according to an embodiment of the disclosure. After determining the cluster center of the cluster corresponding to the workshop accounts and the cluster center of the cluster corresponding to the normal accounts, the electronic device determines similarities between the target account and the cluster centers, that is, the active behavior timing feature of the target account, through vector compression. The electronic device determines a quantity of 1's in the vector of the target account by using a Hamming weight, and determines a quantity of different pieces of data at same positions between the vector of the target account and a vector corresponding to the clustering center by using a Hamming distance. The electronic device can calculate the active behavior timing feature of the target account based on formulas (1) to (3):

Act(x)=D(x|hw)+D(x|hd) (1)

D(x|hw)=[(HW(x)−HW(T))/(HW(x)−HW(N))]/(HW(T)−HW(N)) (2)

D(x|hd)=HD(x,T)/(HD(x,N)*HD(T,N)) (3)

where Act(x) represents the active behavior timing feature of the target account, D(x|hw) represents a Hamming weight of x, and D(x|hd) represents a Hamming distance of x. x represents a vector corresponding to active behavior data of the target account, hw represents a Hamming weight, hd represents a Hamming distance, T represents a cluster center of a cluster corresponding to workshop accounts, N represents a cluster center of a cluster corresponding to normal accounts, HW(x) represents a Hamming weight of the target account, HW(T) represents a Hamming weight of the cluster center of the cluster corresponding to the workshop accounts, HW(N) represents a Hamming weight of the cluster center of the cluster corresponding to the normal accounts, HD(x,T) represents a Hamming distance between the vector corresponding to the active behavior data of the target account and the cluster center of the cluster corresponding to the workshop accounts, HD(x,N) represents a Hamming distance between the vector corresponding to the active behavior data of the target account and the cluster center of the cluster corresponding to the normal accounts, and HD(T,N) represents a Hamming distance between the cluster center of the cluster corresponding to the workshop accounts and the cluster center of the cluster corresponding to the normal accounts.

To make the foregoing process described by 2021 to 2023 clearer, reference may be made to FIG. 8. FIG. 8 is a schematic diagram of determining an active behavior timing feature according to an embodiment of the disclosure. In FIG. 8, dimension raising is first performed on samples that cannot be distinguished well in two-dimensional space, to obtain a vector representation of active behavior data, then a corresponding clustering center is determined according to a behavior mode of a user, and finally, the vector representation of the active behavior data is compressed.

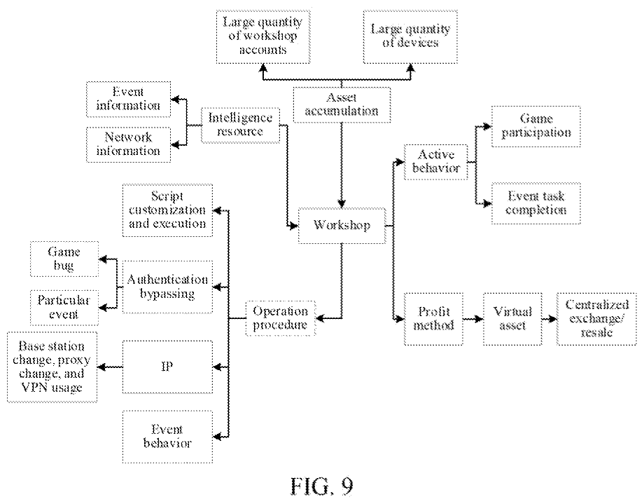

The selection of the active behavior data is related to the target type. The target type being a workshop account type is used as an example. FIG. 9 is a schematic diagram of an operation mode of a workshop according to an embodiment of the disclosure. In FIG. 9, if a workshop needs to accumulate assets, the workshop usually sets a large quantity of devices and a large quantity of workshop accounts. Then, the workshop needs to have intelligence sources to determine profitable gaming scenarios by collecting event information and network information. An operation procedure of a workshop account is usually as follows: A script is customized, and then the script is executed regularly. Authentication is bypassed through game bugs or special events. An IP address of the workshop account is a fixed IP address or is constantly changed in a manner such as changing a base station, changing a proxy server, or using a virtual dedicated network (VPN) and other methods, to increase the difficulty of detection. There are some other event behaviors. The workshop account needs to obtain rewards by participating in the game periodically and completing event tasks. The profit method of the workshop is to exchange or resell virtual assets of a large quantity of workshop accounts in a centralized manner. After the operation mode of the workshop is learned of, active behavior data corresponding to the foregoing behavior mode is collected in a targeted manner.

203: The electronic device determines an account feature of the target account according to the account data of the target account.

In this embodiment of the disclosure, after obtaining account data of at least one target account, the electronic device can further extract a plurality of features from the account data according to the account data. The electronic device can screen the extracted plurality of features, and determine a sifted feature as an account feature. The electronic device can extract a plurality of features from account data based on feature engineering, text preprocessing, a bag-of-words model, and the like, which is not limited in this embodiment of the disclosure.

204. The electronic device predicts, based on the account feature and the active behavior timing feature, a first probability that the target account is of a target type.

In this embodiment of the disclosure, the electronic device inputs the account feature and the active behavior timing feature of the target account into an account detection model. The electronic device performs processing, such as clustering and classification, on the account feature and the active behavior timing feature of the target account based on the account detection model. The output of the account detection model is the first probability that the target account is of the target type.

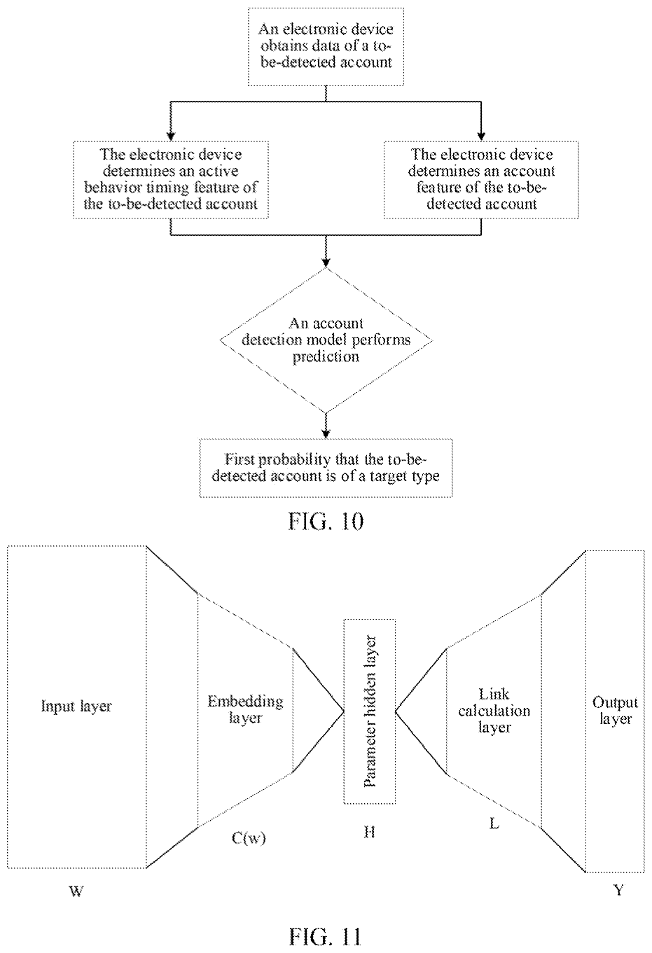

For example, FIG. 10 is a flowchart of another target account detection method according to an embodiment of the disclosure. In FIG. 10, the electronic device obtains data of a target account, and then determines respectively an active behavior timing feature and an account feature of the target account based on the data of target account. The electronic device inputs the active behavior timing feature and the account feature into an input account detection model. The account detection model predicts a first probability that the target account is of a target type.

In some embodiments, the electronic device can alternatively predict the first probability that the target account is of the target type based on the account feature and the active behavior timing feature with reference to a value type of the target account. Correspondingly, this operation is that the electronic device predicts, based on the account feature and the active behavior timing feature, a second probability that the target account is of the target type. The electronic device predicts, according to the account data of the target account, a third probability that the target account is of a target value type. The electronic device determines the first probability according to the second probability and the third probability. The first probability is a predicted probability. The second probability that the target account is of the target type is combined with the third probability that the target account is of the target value type, to introduce the value type of the target account, thereby reducing a false positive rate for accounts of non-target types, and maintaining relatively high coverage while avoiding misjudgments on target value types, such as core accounts, without frequent updates and rebuilding.

In some embodiments, the electronic device can determine a value type of the target account using a value model. For the gaming scenario, because game operation is a continuous service that integrates a plurality of business modes, the value of the target account needs to be considered from a plurality of dimensions, including an explicit value of direct consumption, and also including an implicit value of stimulating other players to make consumption. Therefore, the value model, on the one hand, needs to determine an implicit value of a target account, and on the other hand, needs to quantize continuous investment of the target account in all stages of a life cycle of the game. In some embodiments, the electronic device determines, according to a user portrait in the account data, first value parameters corresponding to features included in the user portrait, that is, determine implicit values of features. The electronic device can further determine a second value parameter corresponding to duration data in the account data, and determine a third value parameter corresponding to consumption data in the account data, that is, quantize continuous investment of the target account within a target duration. The electronic device can input the first value parameter, the second value parameter, and the third value parameter into the value model, process the first value parameter, the second value parameter, and the third value parameter based on the value model, and predict the third probability that the target account is of the target value type.

A method of determining the first value parameters corresponding to features included in the user portrait is similar to a word embedding method in natural language processing. Implicit values brought by the features included in the user portrait, such as the age, the gender, the province, and the city, are measured using the embedding method. Correspondingly, a supervised learning model framework is first constructed. FIG. 11 is a schematic diagram of a supervised learning model framework according to an embodiment of the disclosure. The learning model framework is abstracted into 5 layers: an input layer W, an embedding layer C(w), a parameter hidden layer H, a link calculation layer L, and an output layer Y. Data of an input layer W is an n*d feature matrix W, n is a quantity of input accounts, d is a quantity of features, and n and d are both positive integers. In some embodiments, the input accounts are all target accounts or include at least one target account and at least one sample account of a known type. Each row of the feature matrix W corresponds to a feature-lexicalized vector of an input account. The electronic device maps the features included in the user portrait in the account data into vectors, to obtain a fourth feature matrix. The fourth feature matrix is a row corresponding to the target account in the foregoing feature matrix W. The output layer can be set according to an actual situation by using at least one value parameter that is preset, which is not limited in this embodiment of the disclosure. The parameter hidden layer and the link calculation layer are calculation black boxes, and their internal operation modes are not limited in this embodiment of the disclosure. The electronic device can estimate first value parameters corresponding to the features based on the fourth feature matrix and at least one value parameter that is preset.

In some embodiments, the electronic device can perform calculations of the embedding layer, the parameter hidden layer, and the link calculation layer by using a continuous bag of words (CBOW) algorithm. For an objective function, refer to formula (4).

$$g ( w ) = {\prod }_{u ∈ w ⋃ NEG ( w )} P ( u \vert Context ( w ) ) \qquad ( 4 )$$

where w is a row vector of a feature matrix W of the input layer, and NEG(w) is negative sampling of the feature matrix W of the input layer, so that training samples u include positive and negative samples of the feature matrix W of the input layer. P(u|Context(w)) represents a probability corresponding to each value parameter in at least one value parameter that is preset.

The electronic device can perform parameter estimation using a maximum natural estimation algorithm, that is, find an optimal parameter solution of Max(g(w)), and the output of the embedding layer corresponding to the optimal parameter solution is a first value parameter corresponding to each feature. The output of the embedding layer can be solved by using formula (5):

$$P ( u \vert Context ( w ) ) = σ ( {C ( w )}^{T} {θ}^{u} ) = \frac{1}{1 + {e}^{- {C ( w )}^{T} {θ}^{u}}} \qquad ( 5 )$$

where C(w) is the output of the embedding layer that needs to be solved, θ^{u} is a CBOW algorithm parameter, and T represents transposing a matrix.

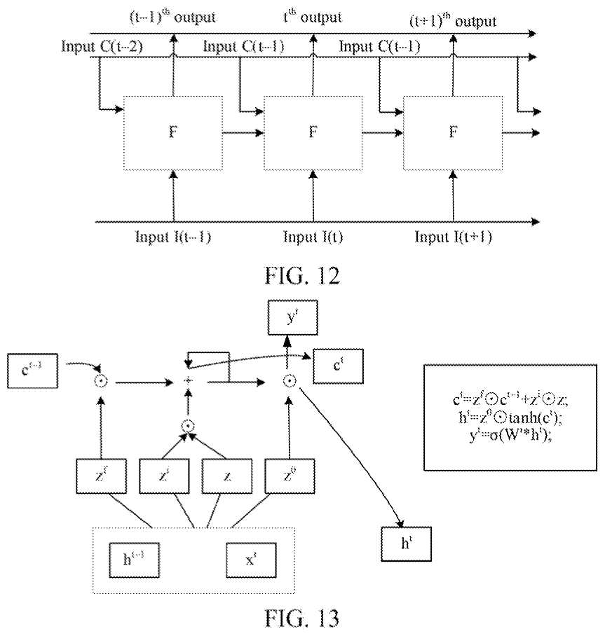

In some embodiments, the value model may have three capabilities: long-term memory learning, time-dependent update learning, and experience learning. For a calculation framework of the value model, refer to FIG. 12. FIG. 12 is a schematic diagram of a learning framework according to an embodiment of the disclosure. FIG. 12 includes three learning functions F. Each round of learning includes a total of three data streams, including two pieces of labeled data, namely, I(t) and C(t). I(t) is the input of a current state and is used for learning the latest content, and C(t) is a state from history to the present and is used for learning the historical content, so that not only time-dependent update learning but also long-term memory learning can be performed. The output of the learning function F is used as the third data stream. That is, a result of this round of learning is used as experience of a next round of learning.

The learning function F is a long short-term memory (LSTM) algorithm. FIG. 13 is a flowchart of a calculation according to an embodiment of the disclosure. In FIG. 13, ⊙ means a Hadamard product, which means that corresponding elements in matrices are multiplied. Therefore, the two multiplied matrices need to be cophenetic matrices. + represents matrix addition. x^{t} represents the t^{th} round of information input of the feature matrix, that is, I(t). h^{t-1} represents learning experience of the (t−1)^{th} round. z is a preliminary comprehensive result of x^{t} and h^{t-1} and is used as new knowledge to be selected and memorized in this round. zⁱ is used for deciding which in z needs to be memorized and learned. z^{f} is used for forgetting partial content in historical learning information c^{t-1} in the previous round, to obtain historical learning information c^{t} of the t^{th} round, c^{t} including the remaining historical learning information after the forgetting and new information. A calculation method of c^{t} is to obtain a sum of a Hadamard product of z^{f} and c^{t-1} and a Hadamard product of zⁱ and z, as shown in formula (6) to formula (9):

c^{t}=z^{f}⊙c^{t-1}+zⁱ⊙z (6)

z^{f}=σ(W^{f}*[x^{t},h^{t-1}]) (7)

zⁱ=σ(Wⁱ*[x^{t},h^{t-1}]) (8)

z=σ(W*[x^{t},h^{t-1}]) (9)

where [ ] represents matrix concatenation, W^{f} represents a neuron weight network matrix corresponding to z^{f} in the LSTM algorithm, Wⁱ represents a neuron weight network matrix corresponding to zⁱ in the LSTM algorithm, W represents a neuron weight network matrix corresponding to z in the LSTM algorithm, σ is the sigma function in mathematics, and * represents multiplication.

z⁰ is used for determining a neuron hidden layer output h^{t} of the t^{th} round, and h^{t} represents learning experience of this round. A calculation method of h^{t} is to obtain a Hadamard product of z⁰ and tanh(c^{t}), as shown in formula (10) and formula (11).

h^{t}=z⁰⊙tanh(c^{t}) (10)

z⁰=σ(W⁰*[x^{t},h^{t-1}]) (11)

where [ ] represents matrix concatenation, tanh( ) is the tanh function in mathematics, W⁰ represents a neuron weight network matrix corresponding to z⁰ in the LSTM algorithm, σ is the sigma function in mathematics, and * represents multiplication.

y^{t} represents the learning output of the t^{th} round, that is, the output of the foregoing learning function F. A calculation method of y^{t} is shown in formula (12):

y^{t}=σ(W′*h^{t}) (12)

where W′ represents a transposed matrix of a neuron weight network matrix in the LSTM algorithm, σ is the sigma function in mathematics, and * represents multiplication.

In some embodiments, the calculation procedure is divided into three stages. The first stage is a forgetting stage. This stage is used for selectively forgetting inputs transmitted from a previous node. A parameter z^{f} of which a value ranges from 0 to 1 is obtained using h^{t-1} and x^{t}. The parameter z^{f} is used as a forget gate. In the states c^{t-1} transmitted from the previous node, which need to be retained and which need to be forgot are controlled by the parameter z^{f}. A calculation method is to obtain a Hadamard product of z^{f} and c^{t-1}. The second stage is a selective memory stage. This stage is divided into two steps. First, which information is updated is determined through an input gate according to h^{t-1} and x^{t}, to obtain a parameter zⁱ. The parameter zⁱ is used as a selection gate, to determine, by using the parameter zⁱ, which are important and which are not important. Then, z is determined according to ^{t-1} and x^{t}, to obtain a Hadamard product of zⁱ and z: zⁱ⊙z. Results obtained in the first stage and the second stage are added, that is, a state c^{t} transmitted to a next node is obtained. The third stage is an output stage. In this stage, an output h^{t} of a current state is determined, control is performed by using a parameter z⁰, and c^{t} is scaled by using the activation function tanh( ). A calculation method is to obtain a Hadamard product of z⁰ and tanh(c^{t}). y^{t} refers to a probability of the output at this stage, is obtained by transforming h^{t}, and has a value range of 0 to 1.

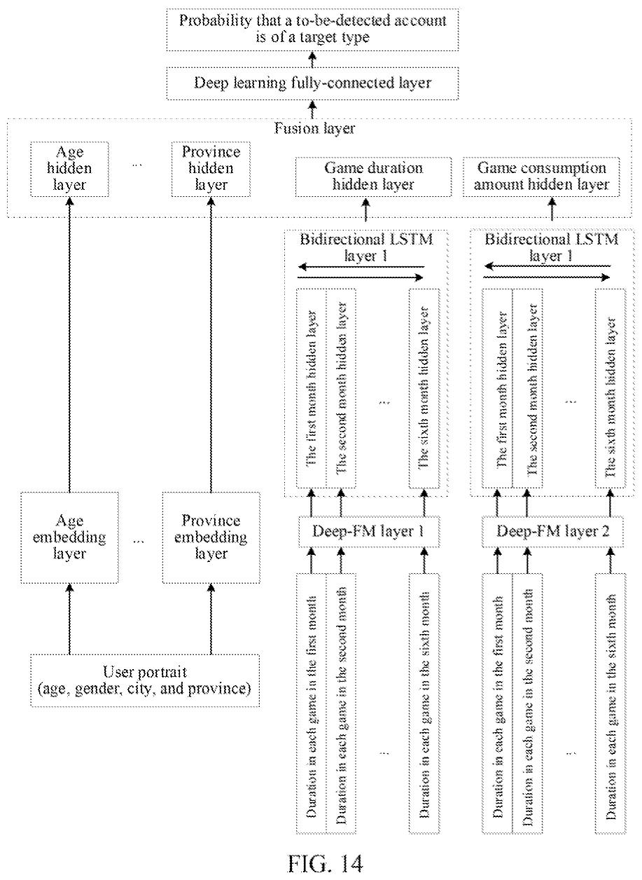

To make a process in which an electronic device determines a value type of a target account by using a value model clearer, FIG. 14 is an architectural diagram of a value model according to an embodiment of the disclosure. In FIG. 14, the electronic device uses a user portrait, an active duration in each game in the last 6 months, and a consumption amount in each game in the last 6 months as inputs of the value model. The user portrait, for example, includes four features, namely, the age, the gender, the city, and the province. The electronic device determines embedding layer outputs of the features of the user portrait using the value model, and uses the embedding layer outputs of the features as hidden layers of the features. The embedding layer can learn of portrait service information better, and reduce a quantity of parameters to some extent. For the active duration in the game in the last 6 months, the electronic device may perform processing by using a deep-factorization machines (Deep-FM) layer in the value model to learn of associated feature information therein, thereby reducing a quantity of parameters and reducing overfitting. A method of processing the consumption amount in the game in the last 6 months is similar to the method of processing the active duration in the game in the last 6 months, and details are not described again. The electronic device processes, by using the foregoing LSTM algorithm, the features processed by the Deep-FM layer, to obtain a game duration hidden layer and a game consumption amount hidden layer. At a fusion layer, hidden layers of features are fused with each other, and a fused result is inputted into a deep learning fully-connected layer, to obtain a probability that the target account is of the target value type.

The foregoing value model can also be used to identify core accounts in the game platform. Indicators are constructed for the core accounts, so that a probability that the target account is a core account is determined from three aspects, namely, the activity, the payment, and the behavior. For example, a plurality of games are connected to a specific game platform in each cycle, and the plurality of games are assessed every week. A rating of a game is measured by analyzing indicators, such as retention, activity, new addition, and payment, corresponding to games on the day of assessment. To obtain a high rating, a game developer may conduct some cheating behaviors, to increase activity of a game of the game developer in a short period of time, and continuously pay for the game in a short period of time, to affect rating the game by the game platform. The game platform may mistakenly consider that the quality of the game is good, which causes the platform to allocate too many resources to the game. However, a high-quality game that does not cheat does not obtain resources it deserves. By using the value model, the game platform can effectively detect a game suspected of cheating, which effectively guides the game platform to allocate resources better. For example, a ratio of a payment amount of non-high-value accounts accounts for 91% during an assessment period, but during a non-assessment period, a ratio of the payment amount of non-high-value accounts only accounts for about 50%. There is a significant difference.

205: The electronic device determines, in response to the first probability being greater than a target probability threshold, that the target account is of the target type.

In this embodiment of the disclosure, when the first probability of the target account is greater than a target probability threshold, the electronic device can determine that the target account is an account of the target type.

In some embodiments, when the electronic device determines the first probability based on the second probability and the third probability, the first probability is a comprehensive probability that the target account is of the target type. In this case, there are two situations: (1) Probability logic contradiction: It is impossible that a target account is an account of a target type at a large probability while being an account of a target value type at a large probability. (2) Probability logic cooperation: The second probability and the third probability support each other or do not contradict each other. The electronic device can determine a final result by changing a confidence that the target account is of the target type, the confidence being used for representing whether a prediction result is logical. In response to the second probability being greater than a first probability threshold, and the third probability is greater than a second probability threshold, the electronic device reduces a confidence that the target account is of the target type. In response to the second probability being greater than the first probability threshold, and the third probability is less than the second probability threshold, the electronic device increases the confidence that the target account is of the target type. In response to the second probability being less than the first probability threshold, and the third probability is greater than the second probability threshold, the electronic device increases the confidence that the target account is of the target type. In response to the second probability being less than the first probability threshold, and the third probability is less than the second probability threshold, the electronic device keeps the confidence that the target account is of the target type unchanged.

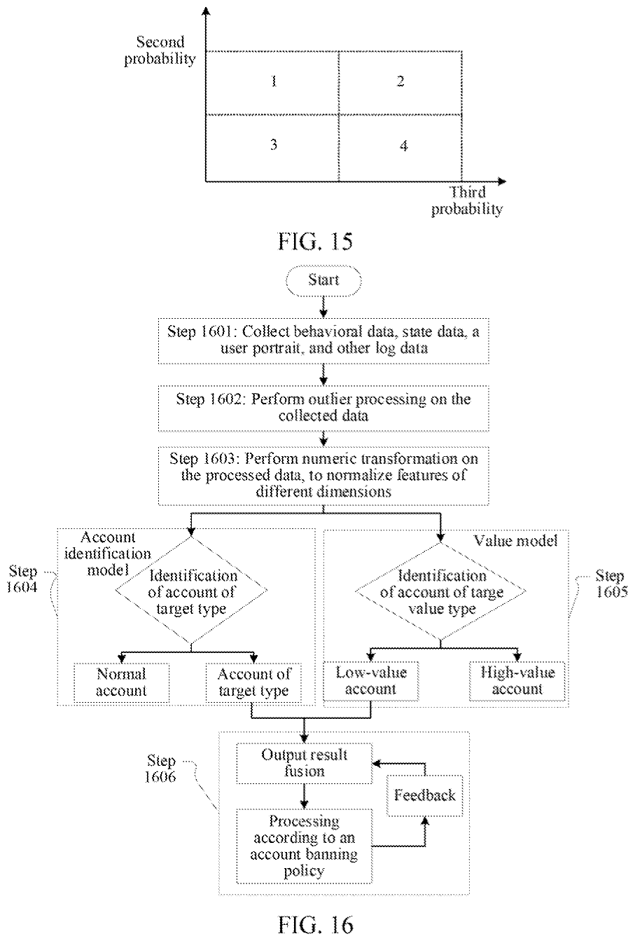

For example, FIG. 15 is a schematic diagram of probability logic according to an embodiment of the disclosure. FIG. 15 includes 4 regions. When the first probability is in a region 1 and a region 4, the electronic device increases the confidence that the target account is of the target type, that is, a prediction result is logical. When the first probability is greater than the target probability threshold, it can be determined that the target account is of the target type. When the first probability is in a region 2, the electronic device reduces the confidence that the target account is of the target type, that is, the prediction result is illogical, and even if the first probability is greater than the target probability threshold, it cannot be determined that the target account is of the target type. When the first probability is in a region 3, the electronic device keeps the confidence unchanged. The first probability can be calculated by using formula (13):

F=P₁*(P₂²)/[|P₁−P₂|*(1−P₁)*(1−P₂)] (13)

where F represents a first probability, P₁ represents a second probability, and P₂ represents a third probability.

206: The electronic device processes the target account according to an account processing rule corresponding to the target type.

In this embodiment of the disclosure, after the electronic device can determine that the target account is an account of the target type, the electronic device processes the target account according to an account processing rule corresponding to the target type. The account processing rule includes login duration restriction, short-time account banning, long-time account banning, account transaction restriction, and the like.

Operation 201 to operation 206 are a possible implementation of the target account detection method provided in this embodiment of the disclosure. In some embodiments, the target account detection method includes other implementations. FIG. 16 is a flowchart of another target account detection method according to an embodiment of the disclosure. In FIG. 16, the target account detection method includes 6 operations: Operation 1601: Collect behavioral data, state data, a user portrait, and other log data. Operation 1602: Perform outlier processing on the collected data. Operation 1603: Perform numeric transformation on the processed data, to normalize features of different dimensions. Operation 1604: Identify target accounts to be detected (or referred to as a to-be-detected account) by using an account identification module, to output normal accounts and accounts of a target type. Operation 1605: Predict the target accounts by using a value model, to output low-value accounts and high-value accounts. Operation 1606: Fuse output results of the account identification model and the value model, and process an account that is both an account of the target type and a low-value account according to an account banning policy. The accuracy of the output results of two models after fusion is verified according to complaints of users of which accounts are banned, and a fusion method of the output results adjusted according to the accuracy.

To verify an implementation effect of fusing output results of models related to detection for an account of target type and target value type detection provided in this embodiment of the disclosure, that is, fusing the two models, a comparison experiment is further carried out in the disclosure. The algorithms used in the comparison experiment are the logical regression (LR) algorithm, the random forest algorithm, and the eXtreme Gradient Boosting (XGB) algorithm. Comparison results are shown in Table 1.

TABLE 1

| | Other solutions | This solution | |
|---|---|---|---|
| Algorithm | Recall rate | Recall rate | Precision rate |
| LR | 78.1% | 96.0% | 97.1% |
| Random forest | 81.0% | 98.2% | 99.9% |
| XGB | 80.5% | 98.0% | 99.8% |

It can be seen from Table 1 that the recall rate of this solution far exceeds the recall rates of other solutions, which indicates that the identification coverage of this solution has been significantly improved. In addition, it can be seen from Table 1 that the precision rate of this solution is kept at a relatively high level when the recall rate is relatively high. That is, this solution not only guarantees the identification coverage, but also improves the accuracy and reduces the false positive rate. The false positive rate can be computed according to the complaint feedback from users: False positive rate=Total quantity of complaint accounts/Total quantity of processed accounts.

In the embodiments of the disclosure, detection can be performed in the dimension of timing by introducing an active behavior timing feature of a target account and determining, according to the active behavior timing feature and an account feature of the target account, a first probability that the target account is of a target type, so that the impact of an account of a target type pretending to be a normal account on detection can be reduced, and more accounts of the target type can be detected, thereby enlarging the identification coverage. In addition, with reference to the probability that the target account is of the target value type, whether a detection result conforms to the actual logic is determined, so as to ensure the accuracy and reduce the false positive rate while ensuring the coverage.

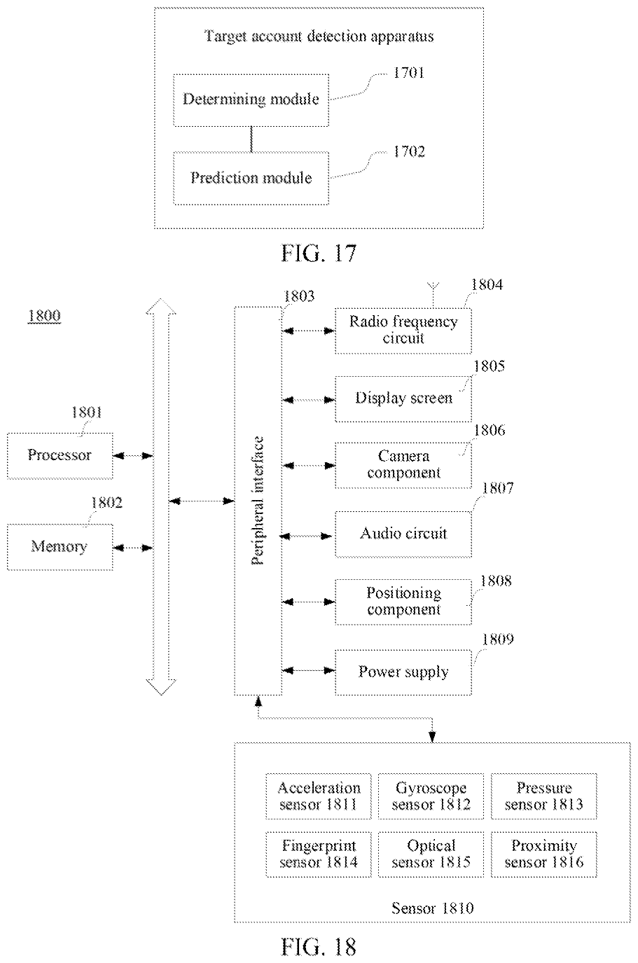

FIG. 17 is a block diagram of a target account detection apparatus according to an embodiment of the disclosure. The apparatus is configured to perform the operations during execution of the foregoing target account detection method. Referring to FIG. 17, the apparatus includes a determining module 1701 and a prediction module 1702.

The determining module 1701 is configured to determine an active behavior timing feature of a target account according to active behavior data of the target account, the active behavior data being used for representing whether the target account is active in a target duration.

The determining module 1701 is further configured to determine an account feature of the target account according to account data of the target account.

The prediction module 1702 is configured to predict, based on the account feature and the active behavior timing feature, a first probability that the target account is of a target type.

The determining module 1701 is further configured to determine, in response to any cluster including a largest quantity of sample accounts, a displacement coefficient of the cluster, the displacement coefficient being a ratio of a quantity of sample accounts not included in the cluster to a total quantity of sample accounts.

The determining module 1701 is further configured to determine a target distance according to a distance between a first clustering center of the cluster and a preset second clustering center and the displacement coefficient, the second clustering center being a clustering center determined in a heuristic clustering manner.

The apparatus further includes: a moving module, configured to move the first clustering center by the target distance in a direction pointing to the second clustering center.

In some embodiments, the determining module 1701 is further configured to obtain, in the at least one cluster, a third clustering center of a first cluster and a fourth clustering center of a second cluster, the first cluster being a cluster corresponding to accounts of the target type, and the second cluster being a cluster corresponding to accounts of non-target types; and process the third clustering center, the fourth clustering center, and the first feature matrix respectively by using a Hamming weight and a Hamming distance, to obtain the active behavior timing feature of the target account, the Hamming weight being used for quantizing an activity level similarity, and the Hamming distance being used for quantizing an activity regularity similarity.

In some embodiments, the prediction module 1702 is further configured to predict, according to the account feature and the active behavior timing feature, a second probability that the target account is of the target type; predict, according to the account data of the target account, a third probability that the target account is of a target value type; and determine the first probability according to the second probability and the third probability.

In some embodiments, the prediction module 1702 is further configured to determine, according to a user portrait in the account data, first value parameters corresponding to features included in the user portrait; determine a second value parameter corresponding to duration data in the account data; determine a third value parameter corresponding to consumption data in the account data; and predict, according to the first value parameter, the second value parameter, and the third value parameter, the third probability that the target account is of the target value type.

In some embodiments, the prediction module 1702 is further configured to map the features included in the user portrait in the account data into vectors, to obtain a fourth feature matrix; and estimate first value parameters corresponding to the features based on the fourth feature matrix and at least one value parameter that is preset.

In some embodiments, the prediction module 1702 is further configured to: reduce, in response to the second probability being greater than a first probability threshold, and the third probability is greater than a second probability threshold, a confidence that the target account is of the target type, the confidence being used for representing whether a prediction result is logical; increase, in response to the second probability being greater than the first probability threshold, and the third probability is less than the second probability threshold, the confidence that the target account is of the target type; increase, in response to the second probability being less than the first probability threshold, and the third probability is greater than the second probability threshold, the confidence that the target account is of the target type; and keep, in response to the second probability being less than the first probability threshold, and the third probability is less than the second probability threshold, the confidence that the target account is of the target type unchanged.

In some embodiments, the apparatus further includes:

an obtaining module, configured to obtain an account processing rule corresponding to the target type; and

an account processing module, configured to process the target account according to the account processing rule.

In some embodiments, the apparatus further includes:

a data processing module, configured to perform outlier processing on collected data, to obtain the account data of the target account; and

a data division module, configured to divide the account data into a plurality of types of data, the active behavior data including at least one type of data,

the data processing module being further configured to perform normalization on the plurality of types of data, the normalization being used for changing a value range of the data into a target value range.

In the embodiments of the disclosure, detection can be performed in the dimension of timing by introducing an active behavior timing feature of a target account and determining, according to the active behavior timing feature and an account feature of the target account, a first probability that the target account is of a target type, so that the impact of an account of a target type pretending to be a normal account on detection can be reduced, and more accounts of the target type can be detected, thereby enlarging the identification coverage.

When the application program is run on the target account detection apparatus provided in the foregoing embodiments, only division of the foregoing function modules is used as an example for description. In the practical application, the functions may be allocated to and completed by different function modules according to requirements. That is, an internal structure of the apparatus is divided into different function modules, to complete all or some of the functions described above. In addition, the target account detection apparatus provided in the foregoing embodiments belongs to the same conception as the embodiments of the target account detection method. For the specific implementation process, reference may be made to the method embodiments, and details are not described herein again.

In the embodiments of the disclosure, the electronic device may be implemented as a terminal or a computer device. When the electronic device is implemented as a terminal, the terminal may implement the operations performed in the target account detection method. When the electronic device is implemented as a computer device, the computer device may implement the operations performed in the target account detection method. Alternatively, the computer device and the terminal interact with each other to implement the operations performed in the target account detection method.

The electronic device may be provided as a terminal. FIG. 18 is a schematic structural diagram of a terminal 1800 according to an embodiment of the disclosure. The terminal 1800 may be a smartphone, a tablet computer, an MP3 player, an MP4 player, a notebook computer, or a desktop computer. The terminal 1800 may also be referred to as another name such as user equipment, a portable terminal, a laptop terminal, or a desktop terminal.

Generally, the terminal 1800 includes a processor 1801 and a memory 1802.

The processor 1801 may include one or more processing cores, for example, a 4-core processor or an 8-core processor. The processor 1801 may be implemented in at least one hardware form of a digital signal processor (DSP), a field-programmable gate array (FPGA), and a programmable logic array (PLA). The processor 1801 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

The memory 1802 may include one or more computer-readable storage media. The computer-readable storage medium may be non-transient. The memory 1802 may further include a high-speed random access memory and a nonvolatile memory, for example, one or more disk storage devices or flash storage devices. In some embodiments, a non-transitory computer-readable storage medium in the memory 1802 is configured to store at least one instruction, the at least one instruction being configured to be executed by the processor 1801 to implement the target account detection method provided in the method embodiments of the disclosure.

In some embodiments, the terminal 1800 may further include a peripheral interface 1803 and at least one peripheral device. The processor 1801, the memory 1802, and the peripheral interface 1803 may be connected by a bus or a signal cable. Each peripheral device may be connected to the peripheral interface 1803 by a bus, a signal cable, or a circuit board. Specifically, the peripheral device includes: at least one of a radio frequency (RF) circuit 1804, a display screen 1805, a camera component 1806, an audio circuit 1807, a positioning component 1808, and a power supply 1809.

The peripheral interface 1803 may be configured to connect the at least one peripheral related to input/output (I/O) to the processor 1801 and the memory 1802. In some embodiments, the processor 1801, the memory 1802 and the peripheral device interface 1803 are integrated on a same chip or circuit board. In some other embodiments, any one or two of the processor 1801, the memory 1802, and the peripheral device interface 1803 may be implemented on a single chip or circuit board. This is not limited in this embodiment.

The RF circuit 1804 is configured to receive and transmit an RF signal, also referred to as an electromagnetic signal. The RF circuit 1804 communicates with a communication network and other communication devices through the electromagnetic signal. The RF circuit 1804 may convert an electric signal into an electromagnetic signal for transmission, or convert a received electromagnetic signal into an electric signal. In some embodiments, the RF circuit 1804 includes: an antenna system, an RF transceiver, one or more amplifiers, a tuner, an oscillator, a digital signal processor, a codec chip set, a subscriber identity module card, and the like. The RF circuit 1804 may communicate with another terminal by using at least one wireless communication protocol. The wireless communication protocol includes, but is not limited to, a metropolitan area network, generations of mobile communication networks (2G, 3G, 4G, and 5G), a wireless local area network, and/or a wireless fidelity (Wi-Fi) network. In some embodiments, the RF 1804 may further include a circuit related to NFC, which is not limited in the disclosure.

The display screen 1805 is configured to display a user interface (UI). The UI may include a graph, text, an icon, a video, and any combination thereof. When the display screen 1805 is a touchscreen, the display screen 1805 is further capable of collecting a touch signal on or above a surface of the display screen 1805. The touch signal may be inputted to the processor 1801 as a control signal for processing. In this case, the display screen 1805 may be further configured to provide a virtual button and/or a virtual keyboard that are/is also referred to as a soft button and/or a soft keyboard. In some embodiments, there may be one display screen 1805 disposed on a front panel of the terminal 1800. In some other embodiments, there may be at least two display screens 1805 respectively disposed on different surfaces of the terminal 1800 or designed in a foldable shape. In still some other embodiments, the display screen 1805 may be a flexible display screen disposed on a curved surface or a folded surface of the terminal 1800. Even, the display screen 1805 may be further set in a non-rectangular irregular pattern, namely, a special-shaped screen. The display screen 1805 may be prepared by using materials such as a liquid crystal display (LCD), an organic light-emitting diode (OLED), or the like.

The camera component 1806 is configured to capture images or videos. In some embodiments, the camera component 1806 includes a front-facing camera and a rear-facing camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1806 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1807 may include a microphone and a speaker. The microphone is configured to acquire sound waves of a user and an environment, and convert the sound waves into an electrical signal to input to the processor 1801 for processing, or input to the radio frequency circuit 1804 for implementing voice communication. For the purpose of stereo sound collection or noise reduction, there may be a plurality of microphones, respectively disposed at different parts of the terminal 1800. The microphone may further be an array microphone or an omni-directional acquisition type microphone. The speaker is configured to convert electrical signals from the processor 1801 or the RF circuit 1804 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1807 may also include an earphone jack.

The positioning component 1808 is configured to position a current geographic location of the terminal 1800, to implement a navigation or a location based service (LBS). The positioning component 1808 may be a positioning component based on the Global Positioning System (GPS) of the United States, the BeiDou system of China, the GLONASS System of Russia, or the GALILEO System of the European Union.

The power supply 1809 is configured to supply power to components in the terminal 1800. The power supply 1809 may be an alternating-current power supply, a direct-current power supply, a disposable battery, or a rechargeable battery. In a case that the power supply 1809 includes the rechargeable battery, the rechargeable battery may support wired charging or wireless charging. The rechargeable battery may be further configured to support a fast charging technology.

In some embodiments, the terminal 1800 further includes one or more sensors 1810. The one or more sensors 1810 include, but are not limited to: an acceleration sensor 1811, a gyroscope sensor 1812, a pressure sensor 1813, a fingerprint sensor 1814, an optical sensor 1815, and a proximity sensor 1816.

The acceleration sensor 1811 may detect acceleration on three coordinate axes of a coordinate system established by the terminal 1800. For example, the acceleration sensor 1811 may be configured to detect components of gravity acceleration on the three coordinate axes. The processor 1801 may control, according to a gravity acceleration signal collected by the acceleration sensor 1811, the touch display screen 1805 to display the UI in a landscape view or a portrait view. The acceleration sensor 1811 may be further configured to acquire motion data of a game or a user.

The gyroscope sensor 1812 may detect a body direction and a rotation angle of the terminal 1800. The gyroscope sensor 1812 may cooperate with the acceleration sensor 1811 to acquire a 3D action by the user on the terminal 1800. The processor 1801 may implement the following functions according to the data acquired by the gyroscope sensor 1812: motion sensing (such as changing the UI according to a tilt operation of the user), image stabilization during shooting, game control, and inertial navigation.

The pressure sensor 1813 may be disposed at a side frame of the terminal 1800 and/or a lower layer of the display screen 1805. When the pressure sensor 1813 is disposed at the side frame of the terminal 1800, a holding signal of the user on the terminal 1800 may be detected. The processor 1801 performs left and right hand recognition or a quick operation according to the holding signal acquired by the pressure sensor 1813. When the pressure sensor 1813 is disposed on the low layer of the display screen 1805, the processor 1801 controls, according to a pressure operation of the user on the display screen 1805, an operable control on the UI. The operable control includes at least one of a button control, a scroll-bar control, an icon control, and a menu control.

The fingerprint sensor 1814 is configured to acquire a user's fingerprint, and the processor 1801 identifies a user's identity according to the fingerprint acquired by the fingerprint sensor 1814, or the fingerprint sensor 1814 identifies a user's identity according to the acquired fingerprint. When identifying that the user's identity is a trusted identity, the processor 1801 authorizes the user to perform related sensitive operations. The sensitive operations include: unlocking a screen, viewing encrypted information, downloading software, paying, changing a setting, and the like. The fingerprint sensor 1814 may be disposed on a front surface, a back surface, or a side surface of the terminal 1800. When a physical button or a vendor logo is disposed on the terminal 1800, the fingerprint sensor 1814 may be integrated with the physical button or the vendor logo.

The optical sensor 1815 is configured to acquire ambient light intensity. In an embodiment, the processor 1801 may control display luminance of the display screen 1805 according to the ambient light intensity collected by the optical sensor 1815. Specifically, in a case that the ambient light intensity is relatively high, the display luminance of the display screen 1805 is increased, and in a case that the ambient light intensity is relatively low, the display luminance of the touch display screen 1805 is reduced. In another embodiment, the processor 1801 may further dynamically adjust a camera parameter of the camera component 1806 according to the ambient light intensity acquired by the optical sensor 1815.

The proximity sensor 1816 is also referred to as a distance sensor and is generally disposed at the front panel of the terminal 1800. The proximity sensor 1816 is configured to collect a distance between the user and the front face of the terminal 1800. In an embodiment, when the proximity sensor 1816 detects that the distance between the user and the front surface of the terminal 1800 gradually becomes smaller, the display screen 1805 is controlled by the processor 1801 to switch from a screen-on state to a screen-off state. In a case that the proximity sensor 1816 detects that the distance between the user and the front surface of the terminal 1800 gradually becomes larger, the display screen 1805 is controlled by the processor 1801 to switch from the screen-off state to the screen-on state.

A person skilled in the art may understand that the structure shown in FIG. 18 does not constitute a limitation to the terminal 1800, and the terminal may include more or fewer components than those shown in the figure, or some components may be combined, or a different component deployment may be used.

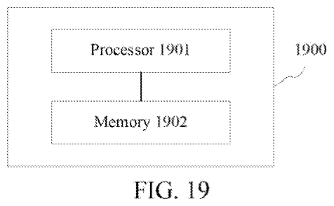

The foregoing electronic device may be provided as a computer device. FIG. 19 is a schematic structural diagram of a computer device according to an embodiment of the disclosure. The computer device 1900 may vary greatly due to different configurations or performance, and may include one or more processors (central processing units (CPUs)) 1901 and one or more memories 1902. The memory 1902 stores at least one instruction, the at least one instruction being loaded and executed by the processor 1901 to perform the target account detection method provided in the foregoing method embodiments. Certainly, the computer device may also have components such as a wired or wireless network interface, a keyboard, and an input/output interface for ease of input/output, and may further include other components for implementing functions of the device. Details are not described herein again.

The embodiments of the disclosure further provide a computer-readable storage medium, applicable to an electronic device, the computer-readable storage medium storing at least one computer program instruction, the at least one computer program instruction being configured to be executed by a processor and implement the operations performed by the electronic device in the target account detection method in the embodiments of the disclosure.

In some embodiments, a computer program or a computer program product is further provided. The computer program product or the computer program includes computer program instructions, and the computer program instructions are stored in a computer-readable storage medium. A processor of an electronic device reads the computer program instructions from the computer-readable storage medium, and executes the computer program instructions, so that the electronic device performs the target account detection method provided in the foregoing aspects or the various optional implementations of the aspects.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of the disclosure, but are not intended to limit the disclosure. Any modification, equivalent replacement, or improvement made within the spirit and principle of the disclosure shall fall within the protection scope of the disclosure.

What is claimed is:

1. A target account detection method, performed by an electronic device, the method comprising:
determining an active behavior timing feature of a target account according to active behavior data of the target account, the active behavior data being used for representing whether the target account is active in a target duration;
determining an account feature of the target account according to account data of the target account;
predicting, based on the account feature and the active behavior timing feature, a first probability that the target account is of a target type; and
determining, in response to the first probability being greater than a target probability threshold, that the target account is of the target type.

2. The method according to claim 1, wherein the determining an active behavior timing feature of a target account according to active behavior data of the target account comprises:
performing dimension raising on the active behavior data of the target account, to obtain a first feature matrix;
performing clustering based on the first feature matrix, to obtain at least one cluster; and
determining the active behavior timing feature of the target account according to the at least one cluster.

3. The method according to claim 2, wherein the performing dimension raising on the active behavior data of the target account comprises:
transforming the active behavior data of the target account into a form of a binomial bitmap, the binomial bitmap referring to that elements in the binomial bitmap are represented by 0 and 1.

4. The method according to claim 2, wherein the performing clustering based on the first feature matrix, to obtain at least one cluster comprises:
combining the first feature matrix and a second feature matrix of at least one sample account into a third feature matrix, a type of the sample account being known;
dividing the third feature matrix into a plurality of feature groups according to a time dimension;
determining similarities between the plurality of feature groups according to a cosine value of a polar coordinate system; and
dividing the plurality of feature groups into the at least one cluster according to the similarities between the plurality of feature groups.

5. The method according to claim 4, wherein after the dividing the plurality of feature groups into the at least one cluster, the method further comprises:
determining, in response to any cluster comprising a largest quantity of sample accounts, a displacement coefficient of the cluster, the displacement coefficient being a ratio of a quantity of sample accounts not comprised in the cluster to a total quantity of sample accounts;
determining a target distance according to a distance between a first clustering center of the cluster and a preset second clustering center and the displacement coefficient, the second clustering center being a clustering center determined in a heuristic clustering manner; and
moving the first clustering center by the target distance in a direction pointing to the second clustering center.

6. The method according to claim 2, wherein the determining the active behavior timing feature of the target account according to the at least one cluster comprises:
obtaining, in the at least one cluster, a third clustering center of a first cluster and a fourth clustering center of a second cluster, the first cluster being a cluster corresponding to accounts of the target type, and the second cluster being a cluster corresponding to accounts of non-target types;
processing the third clustering center, the fourth clustering center, and the first feature matrix respectively by using a Hamming weight and a Hamming distance, to obtain the active behavior timing feature of the target account, the Hamming weight being used for quantizing an activity level similarity, and the Hamming distance being used for quantizing an activity regularity similarity.

7. The method according to claim 1, wherein the predicting comprises:
predicting, according to the account feature and the active behavior timing feature, a second probability that the target account is of the target type;
predicting, according to the account data of the target account, a third probability that the target account is of a target value type; and
determining the first probability according to the second probability and the third probability.

8. The method according to claim 7, wherein the predicting, according to the account data of the target account, a third probability that the target account is of a target value type comprises:
determining, according to a user portrait in the account data, first value parameters corresponding to features comprised in the user portrait;
determining a second value parameter corresponding to duration data in the account data;
determining a third value parameter corresponding to consumption data in the account data; and
predicting, according to the first value parameter, the second value parameter, and the third value parameter, the third probability that the target account is of the target value type.

9. The method according to claim 8, wherein the determining, according to a user portrait in the account data, first value parameters corresponding to features comprised in the user portrait comprises:
mapping the features comprised in the user portrait in the account data into vectors, to obtain a fourth feature matrix; and
estimating first value parameters corresponding to the features based on the fourth feature matrix and at least one value parameter that is preset.

10. The method according to claim 7, wherein the determining that the target account is of the target type comprises:
reducing, in response to the second probability being greater than a first probability threshold, and the third probability is greater than a second probability threshold, a confidence that the target account is of the target type, the confidence being used for representing whether a prediction result is logical;
increasing, in response to the second probability being greater than the first probability threshold, and the third probability is less than the second probability threshold, the confidence that the target account is of the target type;
increasing, in response to the second probability being less than the first probability threshold, and the third probability is greater than the second probability threshold, the confidence that the target account is of the target type; and
keeping, in response to the second probability being less than the first probability threshold, and the third probability is less than the second probability threshold, the confidence that the target account is of the target type unchanged.

11. The method according to claim 1, wherein after the determining that the target account is of the target type, the method further comprises:
obtaining an account processing rule corresponding to the target type; and
processing the target account according to the account processing rule.

12. The method according to claim 1, wherein before the determining an active behavior timing feature of a target account according to active behavior data of the target account, the method further comprises:
performing outlier processing on collected data, to obtain the account data of the target account;
dividing the account data into a plurality of types of data, the active behavior data comprising at least one type of data; and
performing normalization on the plurality of types of data, the normalization being used for changing a value range of the data into a target value range.

13. A target account detection apparatus, comprising:
at least one memory configured to store program code; and
at least one processor configured to read the program code and operate as instructed by the program code, the program code comprising:
determining code configured to cause the at least one processor to determine an active behavior timing feature of a target account according to active behavior data of the target account, the active behavior data being used for representing whether the target account is active in a target duration,
the determining code being further configured to determine an account feature of the target account according to account data of the target account; and
prediction code configured to cause the at least one processor to predict, based on the account feature and the active behavior timing feature, a first probability that the target account is of a target type,
the determining code being further configured to determine, in response to the first probability being greater than a target probability threshold, that the target account is of the target type.

14. The apparatus according to claim 13, wherein the determining code is further configured to cause the at least one processor to
perform dimension raising on the active behavior data of the target account, to obtain a first feature matrix;
perform clustering based on the first feature matrix, to obtain at least one cluster; and
determine the active behavior timing feature of the target account according to the at least one cluster.

15. The apparatus according to claim 14, wherein the determining code is further configured to cause the at least one processor to transform the active behavior data of the target account into a form of a binomial bitmap, the binomial bitmap referring to that elements in the binomial bitmap are represented by 0 and 1.

16. The apparatus according to claim 14, wherein the determining code is further configured to cause the at least one processor to
combine the first feature matrix and a second feature matrix of at least one sample account into a third feature matrix, a type of the sample account being known;
divide the third feature matrix into a plurality of feature groups according to a time dimension; determine similarities between the plurality of feature groups according to a cosine value of a polar coordinate system; and
divide the plurality of feature groups into the at least one cluster according to the similarities between the plurality of feature groups.

17. The apparatus according to claim 16, wherein the determining code is further configured to cause the at least one processor to
determine, in response to any cluster comprising a largest quantity of sample accounts, a displacement coefficient of the cluster, the displacement coefficient being a ratio of a quantity of sample accounts not comprised in the cluster to a total quantity of sample accounts; and
determine a target distance according to a distance between a first clustering center of the cluster and a preset second clustering center and the displacement coefficient, the second clustering center being a clustering center determined in a heuristic clustering manner, and
the apparatus further comprises:
moving code configured to cause the at least one processor to move the first clustering center by the target distance in a direction pointing to the second clustering center.

18. The apparatus according to claim 14, wherein the determining code is further configured to cause the at least one processor to
obtain, in the at least one cluster, a third clustering center of a first cluster and a fourth clustering center of a second cluster, the first cluster being a cluster corresponding to accounts of the target type, and the second cluster being a cluster corresponding to accounts of non-target types; and
process the third clustering center, the fourth clustering center, and the first feature matrix respectively by using a Hamming weight and a Hamming distance, to obtain the active behavior timing feature of the target account, the Hamming weight being used for quantizing an activity level similarity, and the Hamming distance being used for quantizing an activity regularity similarity.

19. The apparatus according to claim 13, wherein the prediction code is further configured to cause the at least one processor to
predict, according to the account feature and the active behavior timing feature, a second probability that the target account is of the target type;
predict, according to the account data of the target account, a third probability that the target account is of a target value type; and
determine the first probability according to the second probability and the third probability.

20. A non-transitory computer readable storage medium, storing a computer program that when executed by at least one processor causes the at least one processor to:
determine an active behavior timing feature of a target account according to active behavior data of the target account, the active behavior data being used for representing whether the target account is active in a target duration;
determine an account feature of the target account according to account data of the target account;
predict, based on the account feature and the active behavior timing feature, a first probability that the target account is of a target type; and
determine, in response to the first probability being greater than a target probability threshold, that the target account is of the target type.
